(19) United States
(12) Patent Application Publication
(10) Pub. No.: US 2016/0062595 A1
(43) Pub. Date: Mar. 3, 2016

(54) ELECTRONIC DEVICE AND CONTROL METHOD THEREOF

(71) Applicant: Kabushiki Kaisha Toshiba, Tokyo (JP)

(72) Inventor: Tatsuo Yamaguchi, Kunitachi Tokyo (JP)

(21) Appl. No.: 14/634,072

(22) Filed: Feb. 27, 2015

(30) Foreign Application Priority Data
Aug. 28, 2014 (JP) 2014-173895

(51) Int. Cl. G06F 3/0481; H04L 29/08; G06F 3/0484

(52) U.S. Cl. CPC G06F 3/04812; G06F 3/0484; H04L 67/30

(57) ABSTRACT

According to one embodiment, an electronic device includes storage including an operating system (OS) and circuitry. The circuitry executes the OS capable of creating a first user account and a second user account. The OS comprises a first function for prohibiting, according to a first setting, first functions of the OS out of functions available to the first user account while user has logged in to the second user account. The OS further comprises a second function for prohibiting, according to a second setting, second functions of the OS. One of the second functions coincides with one of the first functions. The first function is prohibited from being active while the second function is active or the second function is prohibited from being active while the first function is active.

### CROSS-REFERENCE TO RELATED APPLICATIONS

This application is based upon and claims the benefit of priority from Japanese Patent Application No. 2014-173895, filed Aug. 28, 2014, the entire contents of which are incorporated herein by reference.

### FIELD

Embodiments described herein relate generally to an electronic device having a multi-account function and its control method.

### BACKGROUND

In recent years, tablet computers have come into wide use. A tablet computer may use, for instance, Android (registered trademark) as an operating system.

Android has a multi-user function, which makes it possible to create a user account of a restricted profile. In the restricted profile, available applications may be restricted, or usable devices of the tablet computer may be restricted, or usable functions of the computer may be restricted, for instance.

If a vendor has installed in a tablet computer an original device which is not supported by the operating system, then the restriction functions provided by a restricted profile cannot impose restrictions on using the device. To cope with this problem, the vendor may provide a restriction application for imposing restrictions on using the device.

The restriction function of the restriction application makes it possible to impose restrictions on using the original device but may overlap with the restriction function normally incorporated in the operating system.

When a first restriction function provided by a restricted profile overlaps a second restriction function provided by the restriction application, and when one grants permission while the other imposes prohibition, then the behavior of the computer will be confusing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an exemplary external appearance of an electronic device in the embodiment;

FIG. 2 is an exemplary block diagram illustrating an exemplary system configuration of the electronic device in the embodiment;

FIG. 3 is an exemplary view explaining a function restriction function, which is normally incorporated in the operating system, and an extended function restriction function, which a vendor independently incorporated;

FIG. 4 is an exemplary view illustrating the process of installing a mobile device manager (MDM) application and a control application, the process of activating a vendor device manager (VDM) application, and the process of validating an extended function restriction module;

FIG. 5 is an exemplary flowchart illustrating an exemplary process in which the extended function restriction module imposes restrictions on the functions of the computer in accordance with the extended function restriction configuration information;

FIG. 6 is an exemplary flowchart illustrating an exemplary process in which the extended function restriction module imposes restrictions on the functions of the computer in accordance with the extended function restriction configuration information in which using restricted profiles is allowed; and

FIG. 7 is an exemplary view illustrating an exemplary interface for creating standard function restriction configuration information displayed on a liquid crystal display (LCD) by a standard function restriction configuration application.

### DETAILED DESCRIPTION

Various embodiments will be described hereinafter with reference to the accompanying drawings.

In general, according to one embodiment, an electronic device comprises storage and circuitry. The storage comprises an operating system. The circuitry is configured to execute the operating system capable of creating a first user account and a second user account. The operating system comprises a first restriction function for prohibiting, according to a first setting, first functions of the operating system out of functions available to the first user account while user has logged in to the second user account. The operating system further comprises a second restriction function for prohibiting, according to a second setting, second functions of the operating system. One of the second functions coincides with one of the first functions. The first restriction function is prohibited from being active while the second restriction function is active or the second restriction function is prohibited from being active while the first restriction function is active.

First of all, the structure of the electronic device in the embodiment will be explained. The electronic device may be a portable device such as a tablet computer, a laptop computer, a notebook computer, or a personal digital assistant (PDA). In the following, it is assumed that the electronic device is a tablet computer 10 (hereinafter referred to as a “computer 10”).

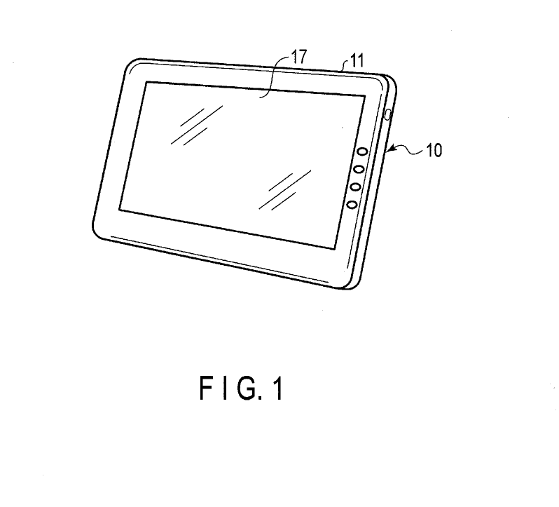

FIG. 1 illustrates the external appearance of the computer 10. The computer 10 comprises a computer body 11 and a touch screen display 17. The computer body 11 is a thin box case. The touch screen display 17 is arranged on the surface of the computer body 11. The touch screen display 17 has a flat-panel display (for instance, a liquid crystal display (LCD)) and a touch panel. The touch panel is provided to cover the screen of the LCD. The touch panel is constructed to detect a location where a user touches the touch screen display 17 with his or her finger or stylus.

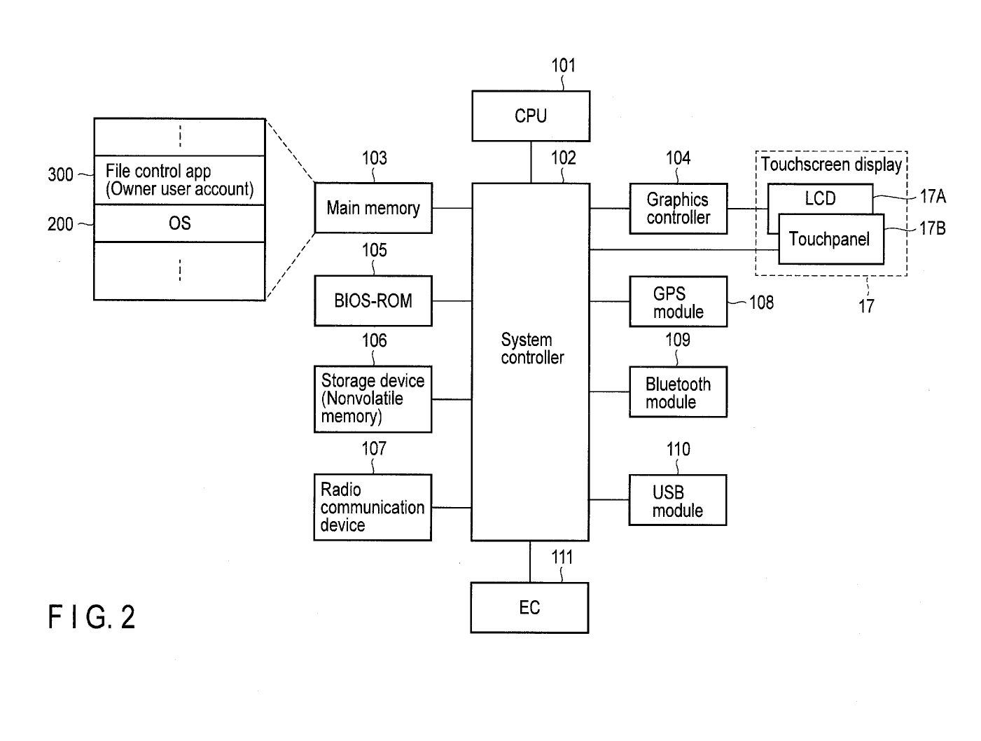

FIG. 2 is a block diagram illustrating a system configuration of the computer 10.

The computer 10 comprises as illustrated in FIG. 2 the touch screen display 17, a central processing unit (CPU) 101, a system controller 102, a main memory 103, a graphics controller 104, a basic input output system read-only memory (BIOS-ROM) 105, a nonvolatile memory 106, a radio communication device 107, a global positioning system (GPS) module 108, a Bluetooth (registered trademark) module 109, a Universal Serial Bus (USB) module 110, and an embedded controller (EC) 111.

The CPU 101 is a processor for controlling the operation of each module in the computer 10. The CPU 101 executes various pieces of software loaded from the nonvolatile memory 106, which is a storage device, to the main memory 103, which is a volatile memory. An operating system (OS) 200 and various application programs are included in the software.

The CPU 101 also executes a basic input output system (BIOS) stored in the BIOS-ROM 105. The BIOS is a hardware control program.

The system controller 102 is a device for connecting the local bus of the CPU 101 and various components. The system controller 102 is equipped with a memory controller for performing access control of the main memory 103. The system controller 102 also has a function of communicating with the graphics controller 104 through a serial bus of a PCI EXPRESS standard or the like.

The graphics controller 104 is a display controller for controlling the LCD 17A that is used as a display monitor of the computer 10. The graphics controller 104 generates a display signal, which is supplied to the LCD 17A. The LCD 17A displays a screen image based on the display signal. A touch panel 17B is arranged on the LCD 17A. The touch panel 17B is a capacitance type pointing device enabling the user to execute input using the screen of the LCD 17A. The touch panel 17B detects a contact position where a finger or a stylus of the user touches the screen and the movement of the contact position.

The radio communication device 107 is a device configured to conduct radio communication such as a wireless LAN or a 3G mobile communication. An EC 111 is a single-chip microcomputer including an embedded controller for power management. The EC 111 has a function of rendering on or off the tablet computer 10 in response to the user's operation of the power button.

The GPS module 108 receives a signal including time information generated by an atomic clock and transmitted from a satellite, and calculates three-dimensional position information of the received location based on the information included in the received signal. The Bluetooth module 109 conducts communication conforming to the Bluetooth (registered trademark) standard. The USB module 110 conducts communication conforming to the USB standard.

In the multi-user function of the operating system 200, a restricted profile can be created, in which the functions that a user can use are restricted. In the restricted profile, available applications may be restricted, or usable devices of the computer 10 may be restricted. For instance, the user of the restricted profile is prohibited from obtaining the position information determined by the GPS module 108.

The vendor of the computer 10 may incorporate into the computer 10 a device whose availability cannot be properly regulated by the function of the restricted profile. In such a case, the vendor may further incorporate for shipment into the computer 10 a function of imposing restrictions on the availability of the incorporated device in order to properly impose restrictions on the availability of the incorporated device and to surely prevent a user of the restricted profile from using the incorporated device.

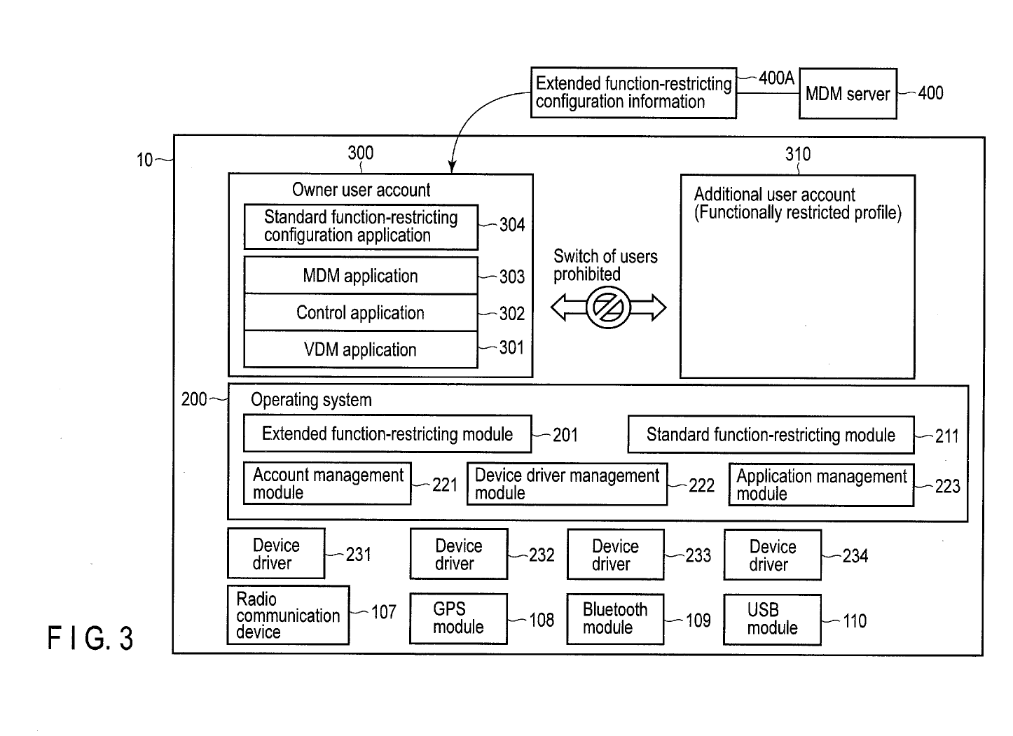

FIG. 3 is a view for the purpose of explaining a function restriction function, which is normally incorporated in the operating system, and an extended function restriction function, which is independently incorporated by a vendor.

The computer 10 is arranged to have an owner user account 300 and an additional user account 310 which belongs to a functionally restricted profile.

A vendor device manager (VDM) application 301, a control application 302, a mobile device manager (MDM) application 303, a standard function restriction configuration application 304 are installed in the owner user account 300. The VDM application 301, the control application 302 and the MDM application 303 are applications provided by the vendor. The standard function restriction configuration application 304 is an application provided by a developer of the operating system 200.

A standard function restriction module 211 and an extended function restriction module 201 are integrated into the operating system 200.

The standard function restriction module 211 is integrated into the operating system 200 by the operating system supplier.

The extended function restriction module 201 is integrated into the operating system 200 by the vendor. The extended function restriction module 201 is capable of imposing restrictions not only on the availability of the device which the vendor originally installed in the computer 10, but also on the availability of those functions of the operating system 200 which are free from availability restriction imposed by the standard function restriction module 211.

When a user has logged in using a user account of a restricted profile, the standard function restriction module 211 prohibits the use of the plurality of first functions of the operating system according to the standard function restriction configuration information, whereby the use of certain devices or the activation of certain applications will be prohibited.

An account management module 221, a device driver management module 222, and an application management module 223 are incorporated in the operating system 200. The account management module 221 controls the switch of user accounts. The device driver management module 222 is capable of loading or unloading a device driver which will be described later. The application management module 223 controls the activation of an application. The application management module 223 is capable of prohibiting the activation of an unspecified application.

A device driver 231 for the radio communication device 107, a device driver 232 for the GPS module 108, a device driver 233 for the Bluetooth module 109, and a device driver 234 for the USB module 110 are installed in the computer. Each of the device drivers mediates between a corresponding one of the devices (modules) and the operating system 200, and makes it possible for an application to use the function of the one of the devices (modules).

In response to the input operation of the user, the standard function restriction configuration application 304 creates standard function restriction configuration information, which includes configuring applications available to the additional user account or determining whether using the position information is allowed. The standard function restriction configuration application 304 notifies the standard function restriction module 211 of the standard function restriction configuration information. Upon changing to the additional user account, the standard function restriction module 211 imposes restrictions on the functions of the operating system 200 according to the standard function restriction configuration information, whereby the use of the devices or the activation of the applications will be restricted.

The MDM application 303 acquires from a mobile device management server (MDM server) 400 extended function restriction configuration information 401, which includes function restriction information of the computer 10. The MDM application 303 transfers the extended function restriction configuration information 401 to the control application 302. The control application 302 activates the VDM application 301, and transfers to the VDM application 301 the extended function restriction configuration information 401. The VDM application 301 activates the extended function restriction module 201, and transfers to the extended function restriction module 201 the extended function restriction configuration information 401. According to the extended function restriction configuration information 401, the extended function restriction module 201 prohibits the use of the plurality of second functions of the operating system 200, the second functions being partially identical to the plurality of first functions which are restricted by the standard function restriction module 211, whereby the use of certain devices or the activation of certain applications will be prohibited.

The configuration of prohibiting the use of any restricted profiles is described in the extended function restriction configuration information 401 in order to prohibit the standard function restriction module 211 from being active. The extended function restriction module 201 requests the account management module 221 to prohibit using restricted profiles. In response to the request, the account management module 221 prohibits using restricted profiles. Due to the prohibition of using restricted profiles, not only a change to a user account of a restricted profile will be prohibited but also an addition of a new restricted profile will be prohibited.

The configuration of an application, whose activation is permitted, is described in the extended function restriction configuration information 401. Based on the extended function restriction configuration information 401, the extended function restriction module 201 notifies the application management module 402 of information on an application which is permitted to be active, and requests the prohibition of activating those applications that are not permitted to be active.

How to configure a device which is permitted to be used is described in the extended function restriction configuration information 401. Based on the extended function restriction configuration information 401, the extended function restriction module 201 requests the device driver management module 403 to unload the driver for driving a device that is prohibited from being active. The device that is prohibited from being active cannot be used after the driver for the device has been unloaded. Alternatively, it is possible to use a Mandatory access control (MAC) function, which the operating system 200 has, to permit or prohibit using the device. Furthermore, it is alternatively possible to change the configuration of a device driver to permit or prohibit using the device.

It should be noted that the MDM application 303 and the control application 302 are not installed at the shipment of the computer 10. Furthermore, the user cannot activate the VDM application 301 at the shipment of the computer 10. In addition, the function that the extended function restriction module 201 has in order to impose restrictions on the functions of the operating system 200 is disabled at the shipment of the computer 10.

Let us suppose that a user has logged-in using a user account of a restricted profile, and that the function restriction functions provided by the standard function restriction module 211 overlap with the function restriction functions provided by the extended function restriction module 201. Under such a condition, if the use of the overlapping functions is permitted by one of the modules whereas prohibited by the other of the modules, then it will be quite difficult for the user to understand the behavior of the computer.

Therefore, when the function restriction provided by the extended function restriction module 201 is active, the function restriction provided by the extended function restriction module 201 is made inactive. Since the function restriction provided by the extended function restriction module 201 is inactive, a situation in which one grants permission whereas the other imposes prohibition will be prevented and thus it becomes possible to prevent the user from being perplexed with the unpredictable behavior of the computer.

When the function restriction provided by the extended function restriction module 201 is active, the extended function restriction module 201 prohibits the change to the function restricted user in order to inactivate the function restriction provided by the extended function restriction module 201. Furthermore, when the function restriction provided by the extended function restriction module 201 is active, the extended function restriction module 201 prohibits newly creating a function restricted user.

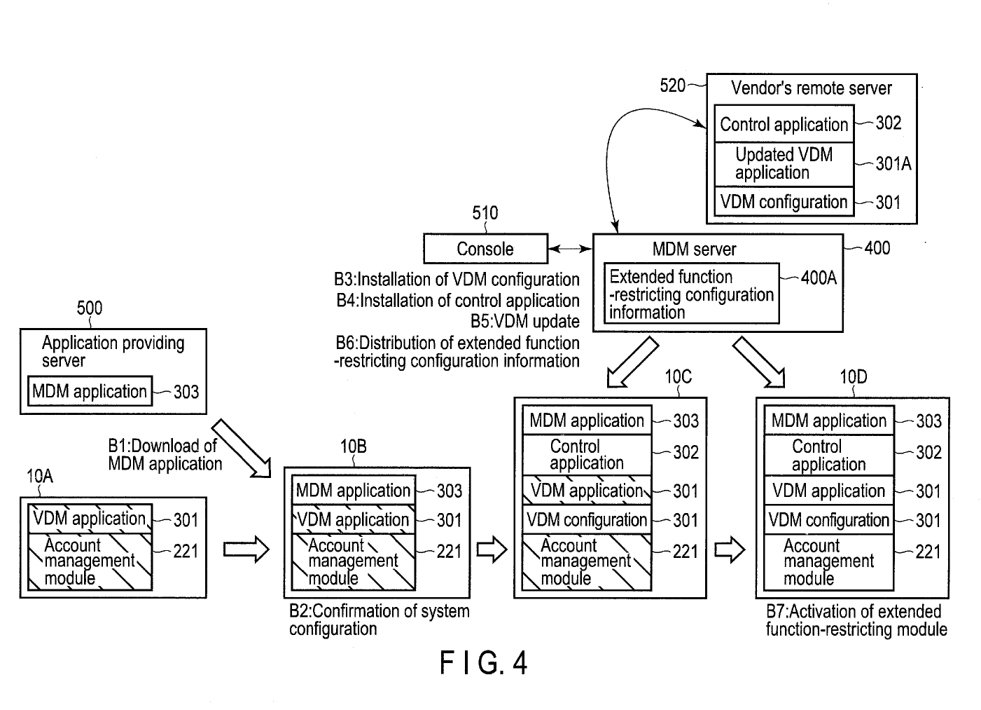

FIG. 4 is a view illustrating the process of installing an MDM application 303 and a control application 302, the process of starting a VDM application 301, and the process of activating an extended function restriction module 201.

A computer in its initial state is illustrated as a computer 10A, wherein the VDM application 301 is installed into the owner user account and the account management module 221 is incorporated into the operating system 200. It should be noted that the VDM application 301 and the account management module 221 are not active.

In response to the input operation of the user or the administrator, the MDM application 303 is downloaded to the computer 10A from an application providing server 500 set up by an operating system providing company, and the MDM application 303 is installed into the owner user account of the computer 10A (Block B1).

The administrator operates a console 510, and requests the MDM application 303, with using the MDM server 400, to notify the administrator whether or not the extended function restriction module 201 is installed in the operating system (Block B2). When there is a response to the request from the MDM application 303 indicating that the extended function restriction module 201 is installed in the operating system, the administrator operates the console 510 and remotely installs in the owner's account the control application 302 and the VDM configuration, both stored in the vendor's remote server 520 (Blocks B3, B4).

When the VDM application 301 installed in the owner's account is a predecessor of the latest version of the updated VDM application 301A stored in the vendor's remote server 520, the administrator operates the console 510 and remotely updates the VDM application 301 using the latest version of the updated VDM application 301A stored in the vendor's remote server 520 (Block B5). This state is indicated by the computer 100.

The administrator operates the console 510, and distributes to the computer 10 extended function restriction configuration information 400A (Block B6).

The MDM application 303 obtains the distributed extended function restriction configuration information 400A. The MDM application 303 transfers to the control application 302 the extended function restriction configuration information 400A, which it obtained, and requests the activation of the VDM application 301. The control application 302 activates the VDM application 301, transfers to the VDM application 301 the extended function restriction configuration information 401, and requests the VDM application 301 to activate the extended function restriction module 201 (Block B7). The VDM application 301 activates the extended function restriction module 201, and brings the computer 10 into a mobile device management mode. The mobile device management mode imposes restrictions on the functions of the operating system 200 based on the extended function restriction configuration information 401. This state is indicated by the computer 10D.

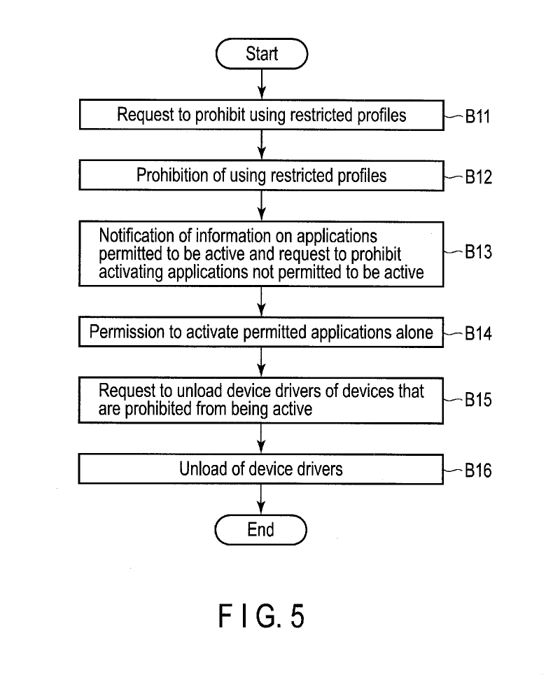

Now, the process in which the extended function restriction module 201 imposes restrictions on the functions of the computer 10 in accordance with the extended function restriction configuration information 400A will be explained. FIG. 5 is a flowchart illustrating an exemplary process in which the extended function restriction module 201 imposes restrictions on the functions of the computer 10 based on the extended function restriction configuration information 400A.

The extended function restriction module 201 requests the account management module 221 to prohibit using restricted profiles (Block B11). The account management module 221 prohibits using restricted profiles (Block B12).

Based on the extended function restriction configuration information 401, the extended function restriction module 201 notifies the application management module 223 of information on an application which is permitted to be active, and requests the prohibition of activating those applications that are not permitted to be active (Block B13). When the activation of an application is requested, the application management module 223 permits activating a permitted application but prohibits activating a prohibited application (Block B14).

Based on the extended function restriction configuration information 401, the extended function restriction module 201 requests the device driver management module 222 to unload the device driver of a device that is prohibited from being active (Block B15). The device driver management module 222 unloads the device driver in response to the request (Block B16).

Following the above procedure, the extended function restriction module 201 imposes restrictions on the functions of the operating system 200.

It is possible to permit a user who can approve the behavior of the device to use a restricted profile. In this case, using the restricted profile may be described in the extended function restriction configuration information.

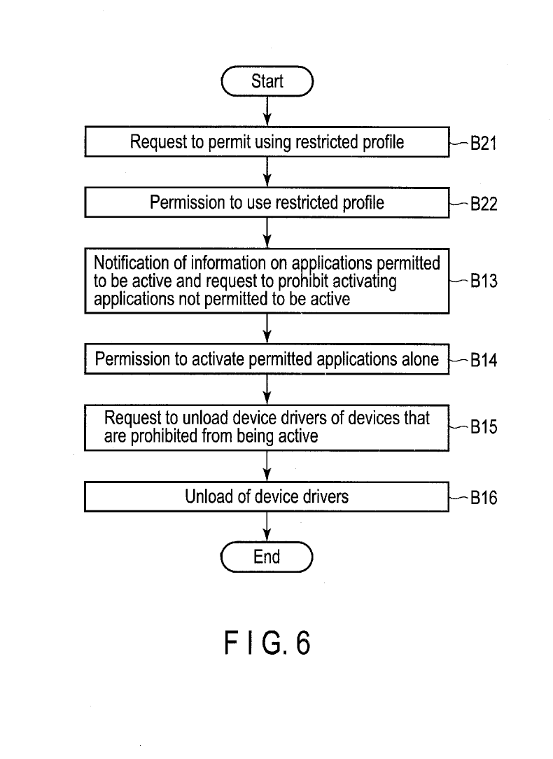

FIG. 6 is a flowchart illustrating an exemplary process in which the extended function restriction module 201 imposes restrictions on the functions of the computer 10 in accordance with the extended function restriction configuration information 400A which permits using the restricted profile.

The extended function restriction module 201 requests the account management module 221 to permit using the restricted profile (Block B21). The account management module 221 permits using the restricted profile (Block B22).

Based on the extended function restriction configuration information 401, the extended function restriction module 201 notifies the application management module 223 of information on an application which is permitted to be active, and requests the prohibition of activating those applications that are not permitted to be active (Block B13). When the activation of an application is requested, the application management module 223 permits activating the permitted application but prohibits activating prohibited applications (Block B14).

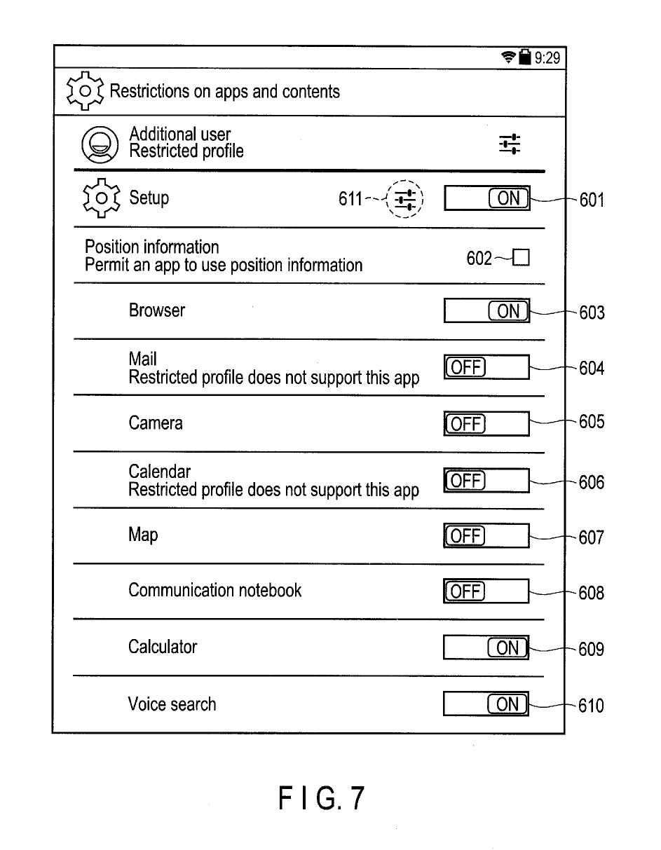

Based on the extended function restriction configuration information 401, the extended function restriction module 201 requests the device driver management module 222 to unload the device driver of a device that is prohibited from being active (Block B15). The device driver management module 222 unloads the device driver in response to the request (Block B16). FIG. 7 is a view illustrating an interface for creating a standard function restriction configuration information displayed on an LCD 17A by a standard function restriction configuration application 304.

As illustrated in FIG. 7, a checkbox 602 for permitting an application to use position information and virtual switches 603 to 610 for causing their respective applications (a browser, mail, a camera, a calendar, a map, an address book, a calculator, and a voice search) to start are displayed for the additional user account. Incidentally, the switches 604 and 606 are illustrated as being off, since using the mail and the calendar is not permitted in the restricted profile. The switch 601 for a setup is always on. The user uses an interface displayed by the standard function restriction configuration application 304 and creates standard function restriction configuration information. The item of the position information can be displayed or hidden by touching the virtual switch 611.

The computer 10 comprises a standard function restriction module 211 capable of executing a first restriction function for prohibiting any of the first functions of the computer 10 based on the standard function restriction configuration information, and an extended function restriction module 201 capable of executing, based on the extended function restriction module 201, a second restriction function for prohibiting any fourth functions including not only the second functions of the computer 10 different from the first functions but also at least one third function forming a part of the first functions. When the second restriction function of the extended function restriction module 201 is active, the first restriction function provided by the standard function restriction module 211 will be prevented from becoming active or, alternatively, when the first restriction function provided by the standard function restriction module 211 is active, the second restriction function provided by the extended function restriction module 201 will be prevented from becoming active. Therefore, it becomes possible to prevent the user from being perplexed with the unpredictable behavior of the computer.

It is alternatively possible for the extended function restriction module 201 to impose restrictions on the functions that are administered by the operating system 200.

It should be noted that the above-mentioned various kinds of processing in the present embodiment can be reduced to a computer program, which makes it possible to easily realize the same effects as the present embodiment only to install the computer program in a computer through a computer readable storage medium storing the computer program and to execute the installed computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
storage comprising an operating system
circuitry configured to execute the operating system capable of creating a first user account and a second user account, wherein
the operating system comprises a first restriction function for prohibiting, according to a first setting, first functions of the operating system out of functions available to the first user account while user has logged in to the second user account,
the operating system further comprises a second restriction function for prohibiting, according to a second setting, second functions of the operating system,
one of the second functions coincides with one of the first functions, and
the first restriction function is prohibited from being active while the second restriction function is active or the second restriction function is prohibited from being active while the first restriction function is active.

2. The device of claim 1, wherein the first setting is created by a user through a user interface, and the second setting is received from a server.

3. The device of claim 1, wherein at least one of switching to the second user account and newly creating the second user account is prohibited on the second restriction function being active.

4. The device of claim 1, wherein, when a first component for obtaining the second setting is installed from a server and a second component for performing the second restriction function is not installed, the circuitry installs the second component.

5. The device of claim 1, wherein the first restriction function is permitted: to be active even though the second restriction function is active as long as the second setting includes information on permission to create the second user account; to log in using the second user account; or to switch to the second user account.

6. A control method of an electronic device having storage comprising an operating system and circuitry executing the operating system capable of creating a first user account and a second user account, wherein
the operating system comprises a first restriction function for prohibiting, according to a first setting, first functions of the operating system out of functions available to the first user account while the user has logged in to the second user account, and
the operating system further comprises a second restriction function for prohibiting, according to a second setting, second functions of the operating system one of the second functions coincides with one of the first functions,
the method comprising:
prohibiting the first restriction function from being active while the second restriction function is active or the method prohibits the second restriction function from being active while the first restriction function is active.

7. The method of claim 6, wherein the first setting is created by the first user through a user interface, and the second setting is received from a server.

8. The method of claim 6, wherein at least one of switching to the second user account and newly creating the second user account is prohibited on the second restriction function being active.

9. The method of claim 6, wherein, in a case where a first component for obtaining the second setting is installed from a server whereas a second component for performing the second restriction function is not installed, the second component is installed.

10. The method of claim 6, wherein the first restriction function is permitted to be active even though the second restriction function is active as long as the second setting includes information on permission to create the second user account, to log in using the second user account, or to switch to the second user account.

11. A computer readable, non transitory storage medium configured to store a computer program which is executable by a computer, the computer program capable of creating a first user account and a second user account, and controlling the computer to execute functions of:
processing a first restriction function of prohibiting, according to a first setting, first functions of the operating system out of functions available to the first user account while a user has logged in to the second user account;
processing a second restriction function for prohibiting, according to a second setting, second functions of the operating system, one of the second functions coinciding with one of the first functions; and
prohibiting the first restriction function from being active while the second restriction function is active or prohibiting the second restriction function from being active while the first restriction function is active.

12. The medium of claim 11, wherein the first setting is created by the user through a user interface, and the second setting is received from a server.

13. The medium of claim 11, the computer program further controlling the computer to execute function of:
upon the second restriction function being active, to prohibit at least one of switching to the second user account and newly creating the second user account.

14. The medium of claim 11, the computer program further controlling the computer to execute function of:
permitting the first restriction function to be active, even though the second restriction function is active, as long as the second setting includes information on permission to create the second user account, to log in using the second user account, or to switch to the second user account.
